(19) United States
(12) Patent Application Publication
(10) Pub. No.: US 2010/0097408 A1
(43) Pub. Date: Apr. 22, 2010

(54) AMBIENT LIGHTING SYSTEM FOR A DISPLAY DEVICE

(75) Inventors: Marcellinus Petrus Carolus Michael Marcellinus, Eindhoven (NL); Bart Andre Salter, Eindhoven (NL); Willem Franciscus Johanne Hoogenstraaten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/517,231

(22) PCT Filed: Dec. 5, 2007
(86) PCT No.: PCT/IB07/54925

§ 371 Date: Jun. 2, 2009

(30) Foreign Application Priority Data
Dec. 7, 2006 (EP) 06125637.6

(51) Int. Cl. G09G 5/10; G09G 3/32; G09G 3/36; G09G 3/28

(52) U.S. Cl. 345/690; 345/83; 345/98; 345/63

(57) ABSTRACT

This invention relates to an ambient lighting system for a display device including an image display region. Controllable light sources that are substantial point-like and disposed in an array are provided, each being adapted to emit a light beam of at least one wavelength onto an region visually appearing to the viewer peripherally surrounding the display. An image analyzer determines the color information from video data of the displayed image, the color information being used as a control parameter for controlling the emission color of the emitted light beams. Due to the substantial point-like property of the light sources along with their arrangement within the array the emitted light beams onto the region forms a pixelated image so as to provide at least a partial extension of the image display region.

### FIELD OF THE INVENTION

The present invention relates to an ambient lighting system for a display device including an image display region, and to a display device comprising such an ambient lighting system.

### BACKGROUND OF THE INVENTION

EP 1 551 178 discloses a so-called Ambilight, which is a concept that enhances the viewing experience when watching TV by means of ambient lighting. The image is extended outside the boundaries of the TV screen. This concept (feature) has been introduced in the market recently and found to have a tremendous positive impact on the sales of high-end LCD TVs equipped with this feature.

In the ambilight concept, as it is implemented at present, by means of low-pressure gas-discharge lamps such as CCFL (cold-cathode-fluorescence) lamps located behind the TV set, an extension of the image is projected on the wall behind the TV. Each lamp creates a ‘pixel’ of light on the wall behind the display (or on a dedicated diffusely reflecting or diffusely transmitting screen attached to the display), where the intensity of each of the lamps can be varied independently. This intensity is derived from the actual video information according to a certain algorithm. In principle, this is done on a frame-to-frame basis.

In all versions of the Ambilight, there is an RGB triplet of CCFL lamps on each side of the display. In other words, there is one pixel of coloured light projected onto the wall for each side of the display (i.e. left, right, top, and bottom), thus, at most 4 pixels in total. This number can be increased somewhat in principle, by reducing the length of the CCFL lamps and putting more lamps side-by-side. 8 pixels in total seem to be an upper limit for reasons of cost.

### BRIEF DESCRIPTION OF THE INVENTION

The object of the present invention is to provide low-cost ambient light system (ambilight) with more resolution.

According to one aspect the present invention relates to an ambient lighting system for a display device including an image display region, comprising:

controllable light sources each being adapted to emit a light beam of at least one wavelength onto region at least partly peripherally surrounding the display region and visually appearing to a viewer,

an image analyzer for determining color information from video data of the displayed image, the color information being used as a control parameter for controlling the emission color of the emitted light beams,

wherein the light sources are substantially point-like disposed in an array, the arrangement of the light sources within the array being such that the positions of the emitted light beams onto the region forms a pixelated image providing at least a partial extension of the image display region.

Due to the small dimension it is possible to arrange the light sources in an array, where typically each of the light sources contributes to one pixel. Thus, a pixelated ambient light surrounding the display is provided, wherein the “pixels” do not only extend along the outer perimeter of the display but also along radial directions. The result thereof is that the resolution of the projected light onto the region becomes higher. Also, due to the small dimension of the light sources the internal arrangement and/or the adjustment of the light sources can easily be changed. By the term color information is meant the color and/or the intensity of the color.

In one embodiment, the point-like light sources comprise Light Emitting Diodes (LEDs).

Unlike gas-discharge lamps, LEDs have the advantage that they are inexpensive and require little space. Due to how localized the light beam is, each LED produces a “spot” of light of at least one color, i.e. a single pixel of at least one color. Thus, it is possible to arrange many LEDs together and therefore generate a two dimensional pixel image (having large number of pixels, i.e. columns and rows) onto the region, thus providing a large colour gamut. Also, with a reasonable number of LEDs, the amount of light being used can be reduced compared to the existing CCFL lamps since these lamps require higher voltage and more expensive drivers.

In one embodiment, the array of the point-like light sources comprises at least two columns and at least two rows of light sources arranged substantially at the periphery or the back side of the display device.

Thus, it is possible to extend illuminated region towards the sides of the display, or the top/bottom, or both.

In one embodiment, the array of the point-like light sources is a frame like-structure comprising at least two rows and two columns of the substantially point-like light sources arranged substantially at the periphery or the back side of the display device.

Thus, it is possible to extend the displayed image not only along the out perimeter of the display but also along radial directions.

In one embodiment, the ambient lighting system further comprises collimators having exits and situated with respect to light sources such that the emitted light beams pass through the collimators and through the exits prior to being emitted onto the region visually appearing to the viewer.

Thus, the angular spread of the light sources when hitting the region is reduced, and thus the resolution of the pixels on the region is enhanced.

In one embodiment, the collimators are selected from:

a tapered funnel in air having light reflecting side walls, and

solid collimators adapted to guide the light from an entrance to an exit by means of total-internal-reflection.

In one embodiment, the ambient lighting system further comprises a refractive optical elements situated in front of the exits of the collimators such that the emitted light beams passing through the exits of the collimators pass through the refractive optical elements.

Thus, an additional degree of collimation is provided.

In one embodiment, the refractive optical elements are selected from:

a positive lens,

a negative lens,

a bi-convex lens, a plano-convex lens, a bi-concave lens or a plano-concave lens,

a fresnel-type lens,

a holographic lens,

active optical elements being connected to a power source for changing the focal length of the optical elements and/or re-directing the beam,

optical elements being manually adjustable for changing the focal length of the optical elements and/or re-directing the beam, for each pixel independently or for several or all pixels on one side of the display together,

a diffuser, including a diffuser with asymmetric diffusing properties, and

a combination thereof.

In one embodiment, re-directional optical elements are situated in front of the refractive optical elements such that the light passing through the refractive optical elements pass through the re-directional optical elements prior to being emitted onto pre-defined locations on the region visually appearing to the viewer.

Thus, the angle position of the light beam emitted by the light sources can be re-directed to the intended location on the region. Also, at least a part of the driving electronics used to drive the light sources may be located on the printed circuit board.

In one embodiment, the re-directional optical elements are selected from:

a transparent film having a repetitive prism-like structures, and

a negative lens covering at least one collimator.

In one embodiment, the substantially point-like light sources are mounted on a printed circuit board, the circuit board being adapted to conduct heat generated by the point-like light sources.

Thus, the circuit board also acts as a “cooling” agent since it conducts the heat produced by the light sources away.

In one embodiment, the ambient lighting system further comprises an adjustment mechanism connected to the substantial point-like light sources for adjusting the light sources, the adjustment including adjusting the angle position of the point-like light sources and the angle position of the emitted light beams.

Thus, in case the distance between the display and the region changes, e.g. due to is resting on a tabletop instead of mounting it directly to the wall, the settings of the light sources can easily be changed by changing the angle position of the light sources and therefore the angle position of the emitted light beam. Therefore, the pixelated ambient light corresponds with the distance between the display and the region.

In one embodiment, the ambient lighting system further comprises an adjustment mechanism comprising electronically adjustable optical element or re-directional optical element based on a liquid-crystal effect for adjusting the angle position of the emitted light beams onto the region visually appearing to the viewer.

Thus, it is possible to optimize the ambiance lighting pattern on the wall when changing the distance between the display and the wall. The most flexible system (albeit not very practical) is the one in which for each pixel on the wall one can adjust the pixel position as well as the pixel size.

In one embodiment, the ambient lighting system further comprises at least one elongated light guide comprising an out-coupling structure, the light guide being coupled to one or more of the substantially point-like light sources such that the emitted light beam emitted by at least one of the substantially point-like light sources becomes conducted into the light guide under an angle such that the light becomes guided by means of total internal reflection until it interacts with the out-coupling structure and becomes coupled out of the light guide.

Thus, in case one wants only few pixels on the wall (say 2 on each side of the display), it is more easy to get the required uniformity while using only few LEDs.

In one embodiment, the ambient lighting system further comprises a re-shaping mechanism for re-shaping the light beams such that each respective pixel in the pixelated regions has a pre-defined shape. In one embodiment, the re-shaping mechanism comprises an optical element formed two or more segments arranged in front of the substantially point-like light sources such that the emitted light means pass through the two or more segments, the shapes of the segments and their internal arrangement being such that the light beam will be re-directed differently to a fixed location on the region visually appearing to the viewer.

It is namely so that in case one projects a round or rectangular beam at an oblique angle onto a wall, the resulting spot on the wall will have an elliptical or trapezoidal shape, respectively. When covering a wall with a number of ellipses or trapezoids, there will always be non-uniformities caused by too much overlap at certain locations and voids at other locations. Thus, by reshaping the beam such that when projected at an oblique angle onto a wall, the resulting spot is e.g. a rectangle, such non-uniformities will be eliminated.

According to another aspect, the present invention relates to a display device including an image display region comprising the ambient lighting system.

In one embodiment, the display device is selected from:

computer monitor display,

cathode ray tube (CRT) display,

a liquid crystal display (LCD),

a plasma discharge display, a projection display,

thin-film printed optically-active display,

or a display using functionally equivalent display technology.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which:

FIG. 1 shows an ambient lighting system for a display device according to the present invention,

FIG. 2 illustrates graphically pixelated ambient light appearing towards a viewer,

FIG. 3-4 illustrates graphically a resolution of the ambient lighting system according to the present invention,

FIG. 5 shows a top view of a display device showing three columns of LEDs,

FIG. 6 shows a front and perspective view of an LED in FIG. 5,

FIG. 7 shows a top-view of an array of LEDs producing 3×3 pixels,

FIG. 8a)-c) shows different embodiments of collimators-re-direction optics,

FIG. 9-12 illustrates alternative ways of distributing the collimators and the spots on the region visually appearing to the viewer behind the display device,

FIG. 13a)-b) illustrates an embodiment of re-shaping the light beams on the region,

FIG. 14a)-b) illustrates an embodiment of a line-source for conducting the light emitted by the LEDs, and

FIG. 15 shows where several rows of light-guides are arranged together to generate more pixels.

### DESCRIPTION OF EMBODIMENTS

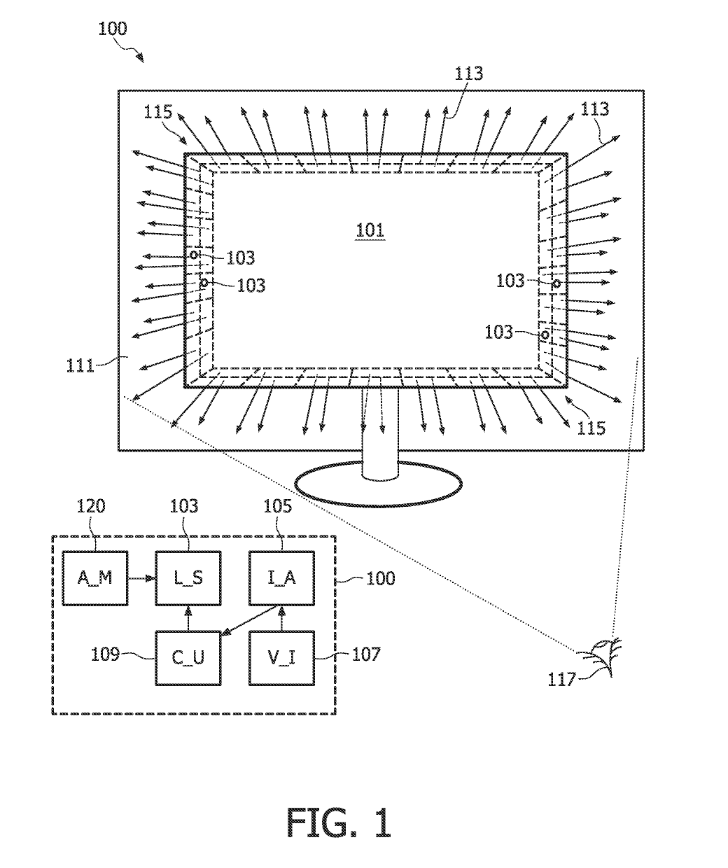

FIG. 1 shows an ambient lighting system 100 for a display device including an image display region 101 according to the present invention adapted to be integrated into new or existing display devices, e.g. TV sets. The display device may be a computer monitor, a cathode ray tube (CRT) display, a liquid crystal display (LCD), an organic LED display (OLED), a plasma discharge display, a projection display, a thin-film printed optically-active display or a display using functionally equivalent display technology.

The ambient lighting system 100 comprises a video input (V_I) 107 for receiving video data to be displayed on the display device, an image analyzer (I_A) 105 for determining the color information from received video data; substantial point-like and controllable light sources (L_S) 103 disposed in an array 115, and a control unit (C_U) for controlling the emission colors of the light sources based on the determined color information. The color information is determined for a predefined measurement area within the display region 101 that preferably covers the periphery of at least one side of the display region 101. The determined color information therefore includes information about the color of the image near (or at) the periphery of the display region 101. Thus, if the light sources (L_S) 103 cover the whole display region 101 the measurement area would preferably include measurement area on the left/right side and the upper/lower side of the display region 101. The operation parameter (the determined color information) for the control unit (C_U) is therefore at any instant of time the colors that are being displayed near (or at) the periphery. As an example, if the left side is red, the light emitted by the light sources (L_S) 103 would preferably be red, whereas if the right side is partly white and partly green, the light emitted by the light sources (L_S) 103 would preferably be partly white and partly green. It would also be possible to process the video input (V_I) 107 such that the determined color information comprise the dominant color near the periphery of the display region 101.

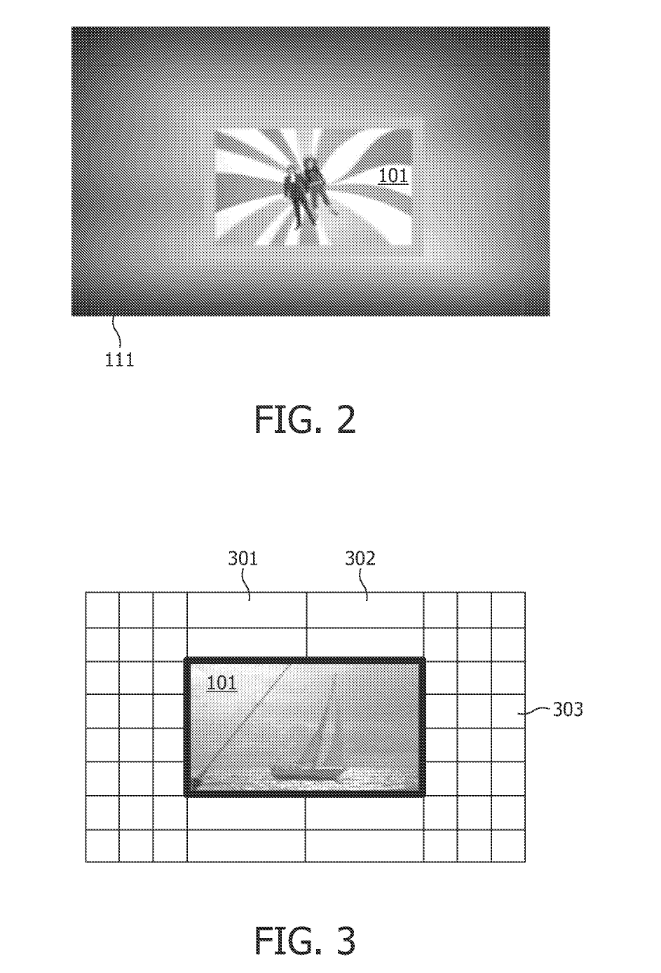

The arrangement of the light sources (L_S) 103 within the array is such that the position of the emitted light beams 113 onto the region visually appearing to the viewer 117, e.g. an ambiance surface peripherally surrounding the display region 101, the at least one ambiance surface peripherally surrounding the display region 101 forms a continuous pixelated image (see FIGS. 2 and 3) acting as an extension of the image display region.

In one embodiment, the substantial point-like light sources 103 are Light Emitting Diodes (LEDs) that emit light of at least one wavelength. Thus, the LEDs may be so-called RGB LEDs (Red-Green-Blue) diodes, or discrete RGB LEDs that emit light of only one wavelength, respectively. Other light sources may also be implemented, such as hybrids between LEDs and lasers such as super-luminescent LEDs.

For simplicity, in the following, it will be assumed that the substantial point-like light sources 103 are LEDs, but other kinds of such light sources are of course also possible.

In one embodiment, the system further comprises an adjustment mechanism (A_M) 120 connected to the substantial point-like light sources for adjusting the light sources, the adjustment including adjusting the angle position of the point-like light sources and/or the angle position of the emitted light beams.

In one embodiment, the array of LEDs 103 is a matrix like arrangement of light sources (or other point-like light sources) comprising one or typically two or more rows and one or typically two or more columns of light sources, which may be mounted to the right and the left sides, and/or to the upper and the lower side behind or substantially at the periphery of the image display region 101 of the display device. Such an array/matrix of light sources is for example provided by mounting the LEDs to a pre-fabricated grid structure that is adapted to the size of the image display region 101.

In another embodiment, the array of light sources 103 comprises a frame structure comprising one or typically two or more rows/columns of LEDs such that the whole ambiance surface 111 peripherally surrounding the display region 101 participates in the display image.

Thus, for a viewer 117, a pixelated ambient light appears towards a viewer 117, where the “pixels” may extend along the outer perimeter of the display, or as illustrated graphically in FIG. 2, additionally along radial directions. Due to the property of the LEDs and the fact that they are arranged in said array, the resolution of the projected light onto the viewing region towards the user, e.g. the ambiance surface behind the display device, becomes very high.

FIG. 3 illustrates graphically a resolution of 3 columns by 4 rows at the left and right side of the display and 2 columns by 2 rows at the top and bottom side. The grid reflects the location of the light spots. In practice, the spots will have a high overlap to obtain smooth light effects. This configuration results in a matrix with 56 addressable pixels, e.g. 301-303.

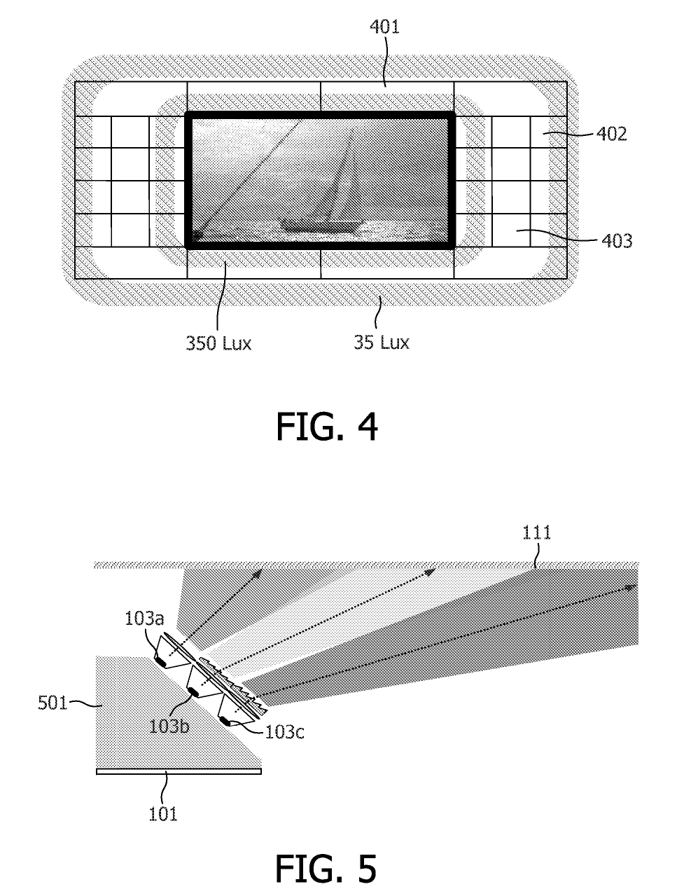

FIG. 4 illustrates graphically a vertical resolution of the top and bottom part which has been reduced from 2 rows to only 1 row. Also the corner section can be reduced from 3 pixels to only one, thus the acceptable resolution is 32 pixels, e.g. 401-403.

In one embodiment, the light output results in a maximum of 35 Lux on the outer border and 350 Lux directly at the screen border. These boundary conditions cannot be fulfilled when using gas-discharge lamps. This is mainly due to their source size. It is such that the light cannot be collimated sufficiently. They can be fulfilled when using LEDs as the light source or other substantially point-like light sources.

Still, the optics required to ‘project’ these pixels accurately (rectangular grid, correct amount of overlap between pixels, color uniformity within a pixel) pose a challenge. Another challenge is posed by the different use cases: a wall mounted set, or a tabletop set (which is much further away from the wall).

FIG. 5 is a top view of a display device 501, e.g. a TV set, showing one back corner of the device and the display region 101. In this embodiment, there are three columns of LEDs 103a-103c. Due to this arrangement, typically three columns of pixels (see FIG. 3) are generated onto the ambiance surface 111, where each LED is responsible for a certain spot, i.e. a pixel on the surface.

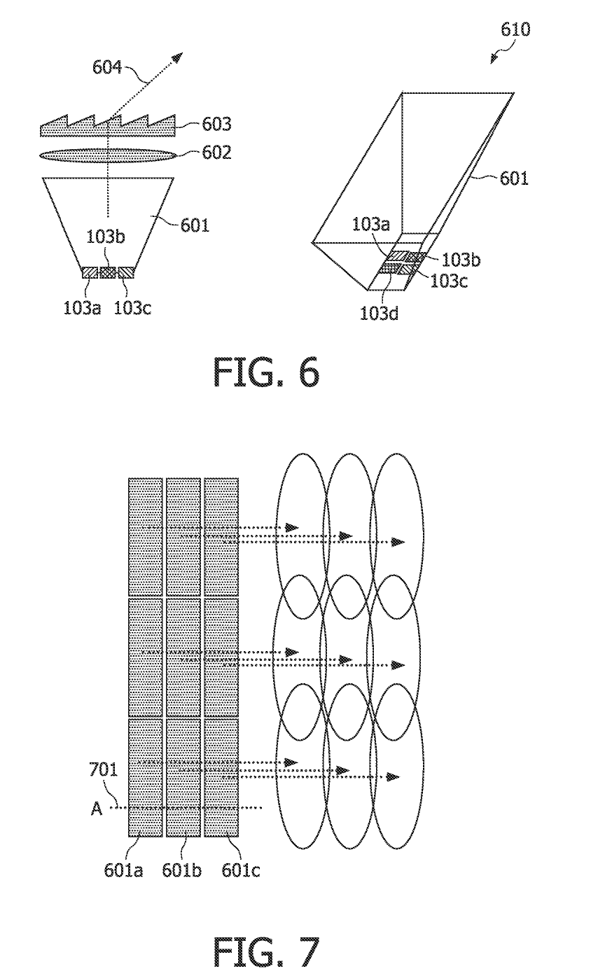

FIG. 6 shows a front and perspective view of the LED in FIG. 5 having exits 610, the LEDs 103a-103d (103d is e.g. a “yellow” LED) being equipped with collimation means 601 for reducing the angular spread of the light towards the ambient surface.

The light of an LED 103a-103d is in most cases emitted in a cone of nearly 180 degrees (corresponding to a solid angle of 2π, i.e. a hemisphere). This angular spread would result in a spot (pixel) on the wall that might be too large. This in turn would result in an overlap between pixels that is by far too large. Some degree of collimation (i.e. reducing the angular spread) is therefore needed. An example of a collimator 601 that is efficient and cost-effective is a tapered funnel in air having highly reflecting sidewalls. The reduction of the angular spread is, by approximation, given by the relation:

$$sin ( {θ}_{out} ) \approx \frac{{D}_{out}}{{D}_{i n}} sin ( {θ}_{i n} ) .$$

Here, θᵢₙ and θₒᵤₜ are the angular spread of the light entering and leaving the collimator, respectively. For an LED without collimating optics, typically, θᵢₙ=90°-180°. Dᵢₙ and Dₒᵤₜ refer to the diameter of the collimator at the entrance and the exit, respectively.

Instead of collimators 601 in air, also solid collimators can be used in which light is guided from the entrance to the exit by means of total-internal-reflection (TIR).

To obtain some additional degree of collimation, a refractive optical element 602 such as a lens can be used. Alternatively, a refractive optical element such as a holographic lens can be used.

To ensure that the light beam 604 (resulting in a spot (pixel)) is directed to the intended location on the ambiance surface, redirection optics 603 are used. In its simplest form, redirection can be done by means of a thin transparent layer having a prism-like relief structure.

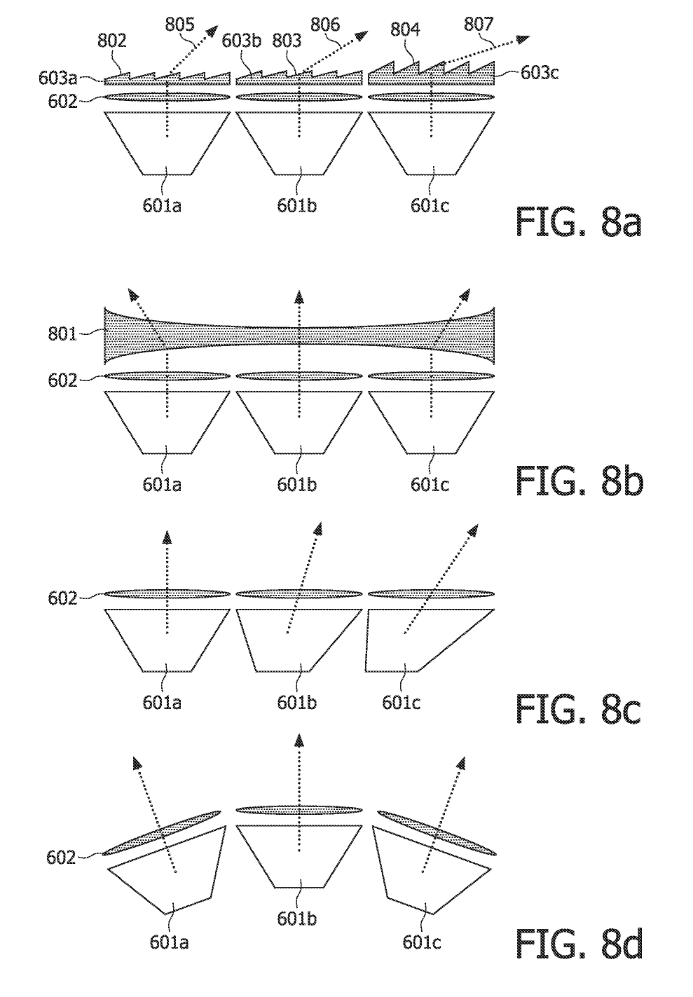

FIG. 7 shows a top-view of an array of LEDs producing 3×3 pixels. Each rectangle corresponds to a single collimator 601a-601c on top of one or more LEDs, and on top of the collimators a redirection optical element is provided. A cross-section along the line labeled A 701 in FIG. 7 is shown in FIG. 8a)-d) illustrating several alternative embodiments of collimators in combination with redirection optics.

In the embodiments shown in FIG. 8a)-c) where the collimators 601a)-601c) have their bottom part lying within the same plane, the LEDs can be mounted on a single flat printed circuit board that also can serve the purpose of conducting heat generated by the LEDs. From a manufacturing point of view, this is an advantage.

In FIG. 8a), the re-directional optical elements 603a-603c are provided having a the prism-like relief structures 603a-603c have slightly different dimensions where e.g. the inclination of the surface 802-804 increases and thus the re-direction of the light beams 805-807. The inclination of these surfaces is preferably optimized in relation to the distance between the array of the LEDs and the ambiance surface behind the display device.

In an embodiment, an adjustment mechanism (not shown) comprising an electronically adjustable optical element or re-directional optical element based on a liquid-crystal effect is provided for adjusting the position of the light emitting beams 805-807 onto the at least one ambient surface.

FIG. 8b) shows a similar arrangement as shown in FIG. 8a), where instead of a negative lens is provided 801 as a re-directional element for re-direction of the light beams. In one embodiment, the focal length for the concave lens is adjustable for compensating for different distances between the display device and e.g. the ambience surface behind the display device.

As an example, for each pixel on the wall one can adjust the pixel position as well as the pixel size. The pixel position may e.g. be changed by means of:

by manually tilting the LED+collimator+optics;

by electronically means by e.g. using an liquid-crystal-based re-direction optical element (for example an LC layer sandwiched between a prism-like structure and a flat substrate; and

by means of electrode layers and a voltage difference, where the LC molecules in the LC layer can be re-oriented, thereby changing the re-direction properties of the optical element.

The pixel size may be changed by e.g. adjusting the focusing properties of the optical elements (manually or electronically) by means of for example an adjustable LC-based lens.

In FIG. 8c) a different shape of the collimators is used to re-direct the light beams. In FIG. 8d) the angular position of the collimators is adjusted such that the emitted light beams hit the ambience surface at the right spots. In one embodiment, this angular position is adjustable, either manually or electronically.

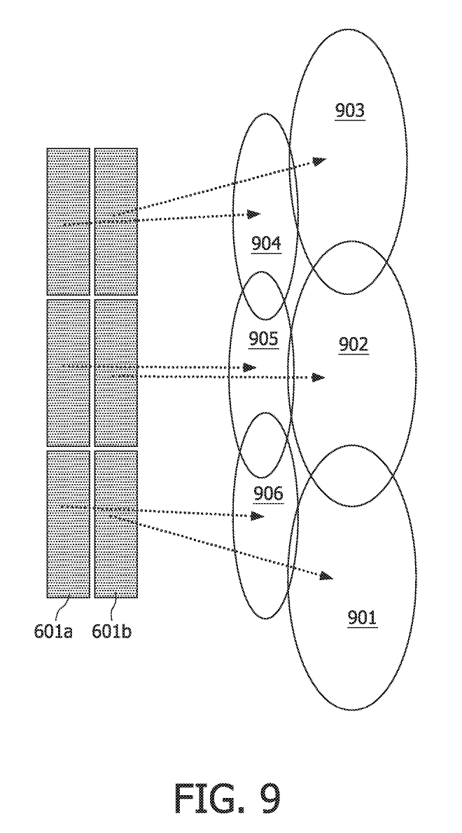

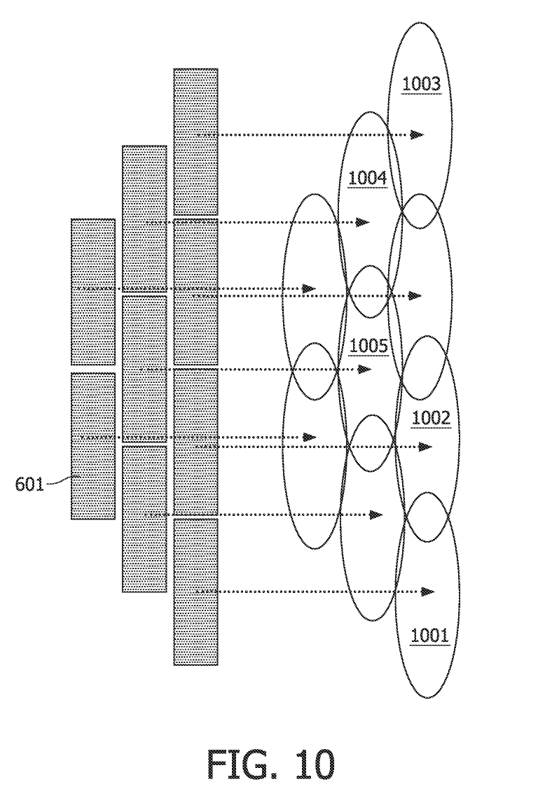

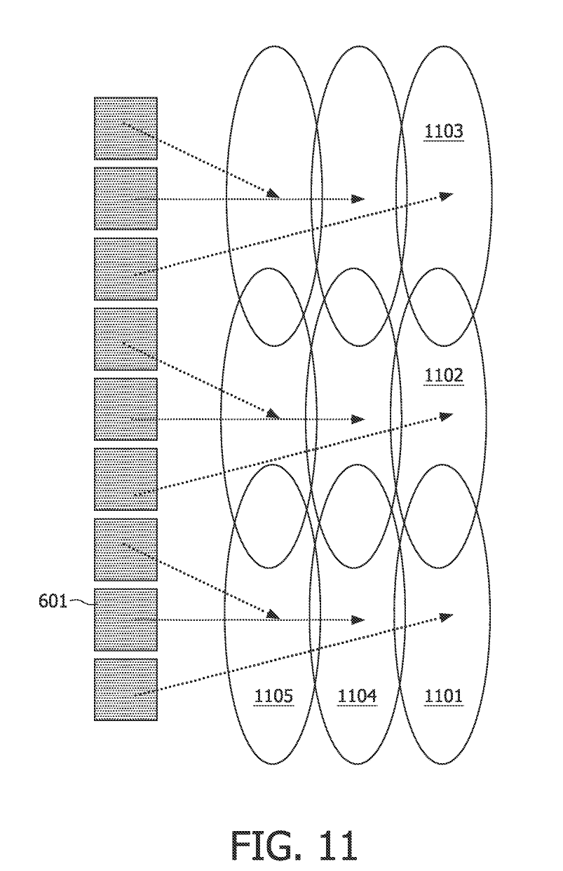

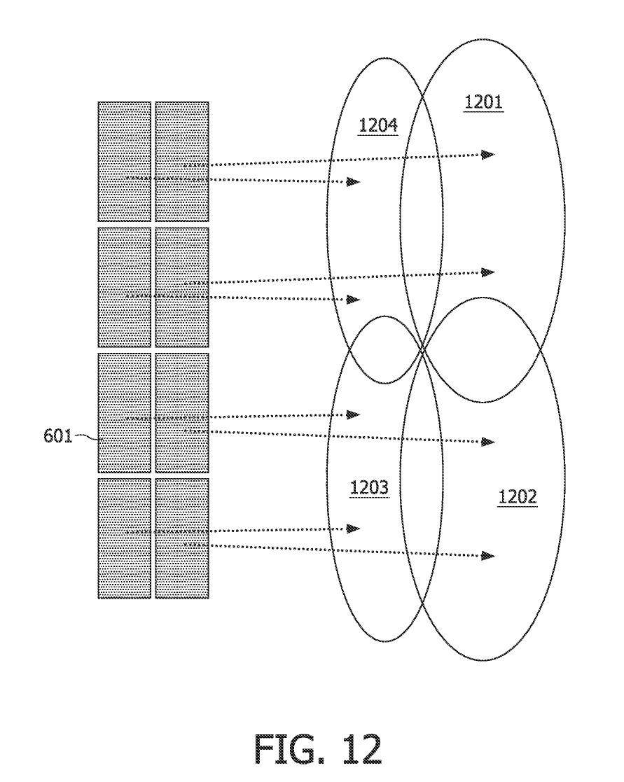

Alternative ways of distributing the collimators and the spots 901-906 (pixels), 1001-1005, 1101-1105, 1201-1204 on the wall are shown in FIG. 9-12. It should be noted that in principle several collimators can be responsible for producing a single spot (pixel). An example is depicted in FIG. 12.

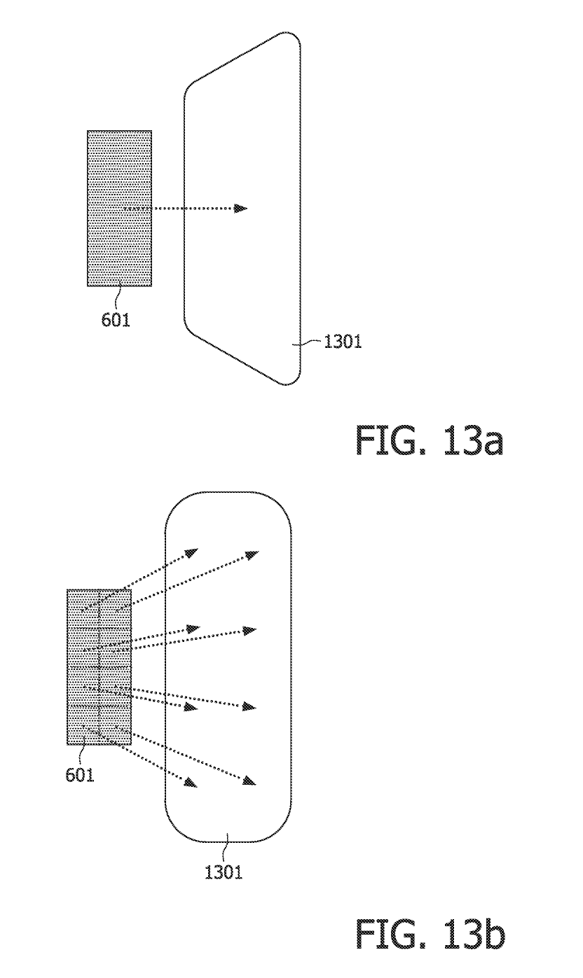

In case one projects a round or rectangular beam at an oblique angle onto a wall, the resulting spot on the wall will have an elliptical or trapezoidal shape, respectively. When covering a wall with a number of ellipses or trapezoids, there will always be non-uniformities caused by too much overlap at certain locations and voids at other locations. It would therefore be advantageous to shape the beam such that when projected at an oblique angle onto a wall, the resulting spot is a rectangle 1301. In one embodiment, this is achieved by sub-dividing an optical element arranged e.g. in front of the collimators 601 into few segments, e.g. 4 slightly different segments such that when the light beam passes the optical element the light becomes split into 4 parts, where each individual part will be directed to a slightly different location on the wall (the region viable towards the user). Thus, the total beam spot on the wall acquires the required shape (for example square instead of round) 1301. Such a scenario is depicted in FIG. 13a) and b).

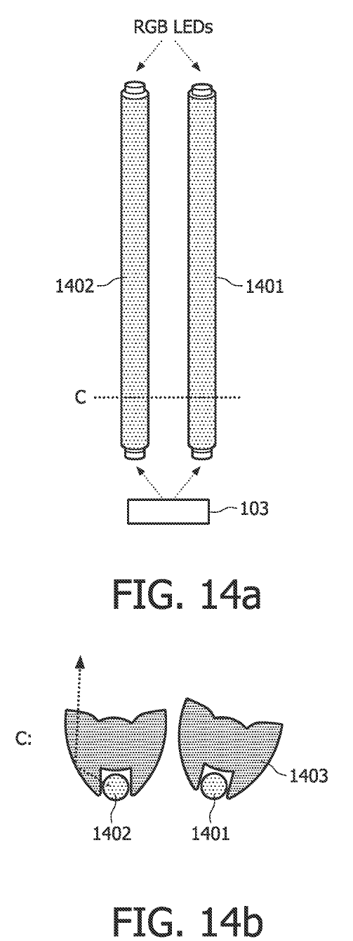

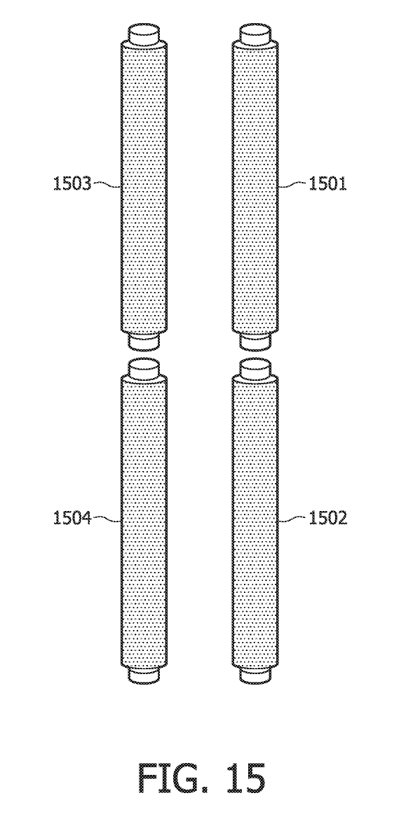

In one embodiment, instead of locating a collimator on top of one or more LEDs, the light from one or more LEDs is used to make a line-source first. This can be done, for example, by means of in-coupling the light from e.g. RGB LEDs into a transparent light-guide 1401-1402 (e.g. a plastic or glass rod), as shown in FIG. 14a). The cross-section of the light-guide can be round, square, triangular etc. The light is guided by means of Total Internal Reflection (TIR). An out-coupling structure on a surface of the light-guide (e.g. dots of white paint) (not shown) may be used to couple light out of the guide 1401-1402. This light can be collimated for example by means of a transparent collimator 1403 that makes use of a combination of TIR and refraction (FIG. 14b). More pixels can be generated by using several rows of light-guides 1501-1504 as shown in FIG. 15.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the spirit and scope of this disclosure. Further, in this context, and for the purposes of brevity and clarity, detailed descriptions of well-known apparatuses, circuits and methodologies have been omitted so as to avoid unnecessary detail and possible confusion.

Reference signs are included in the claims, however the inclusion of the reference signs is only for clarity reasons and should not be construed as limiting the scope of the claims.

1. An ambient lighting system (100) for a display device (501) including an image display region (101), comprising
controllable light sources (103) each being adapted to emit a light beam (113) of at least one wavelength onto region (111) at least partly peripherally surrounding the display region (101) and visually appearing to a viewer (117),
an image analyzer (105) for determining color information from video data of the displayed image, the color information being used as a control parameter for controlling the emission color of the emitted light beams (113),
wherein the light sources (103) are substantially point-like disposed in an array (115), the arrangement of the light sources within the array being such that the positions of the emitted light beams onto the region (111) forms a pixelated image (301-303) providing at least a partial extension of the image display region (101).

2. An ambient lighting system according to claim 1, wherein the point-like light sources (103) comprise Light Emitting Diodes (LEDs).

3. An ambient lighting system according to claim 1, wherein the array (115) of the point-like light sources is a frame like-structure comprising at least two columns and at least two rows of the substantially point-like light sources (103a-103c) arranged substantially at the periphery or the back side of the display device (501).

4. An ambient lighting system according to claim 1, wherein the array (115) of the point-like light sources (103) comprises a frame of the light sources comprising at least two rows and two columns arranged substantially at the periphery or the back side of the display device (501).

5. An ambient lighting system according to claim 1, further comprising collimators (601) having exits (610) and situated with respect to light sources such that the emitted light beams (604) pass through the collimators (601) and through the exits (610) prior to being emitted onto the region (111) visually appearing to the viewer (117).

6. An ambient lighting system according to claim 5, wherein the collimators (601) are selected from:
a tapered funnel in air having light reflecting side walls, and
solid collimators adapted to guide the light from an entrance to an exit by means of total-internal-reflection.

7. An ambient lighting system according to claim 5, further comprising a refractive optical elements (602) situated in front of the exits of the collimators such that the emitted light beams passing through the exits of the collimators pass through the refractive optical elements (602).

8. An ambient lighting system according to claim 7, wherein the refractive optical elements (602) are selected from:
a positive lens,
a negative lens,
a bi-convex lens, a plano-convex lens, a bi-concave lens or a plano-concave lens,
a fresnel-type lens,
a holographic lens,
active optical elements being connected to a power source for changing the focal length of the optical elements and/or re-directing the beam,
optical elements being manually adjustable for changing the focal length of the optical elements and/or re-directing the beam, for each pixel independently or for several or all pixels on one side of the display together,
a diffuser, including a diffuser with asymmetric diffusing properties, and
a combination thereof.

9. An ambient lighting system according to claim 7, wherein re-directional optical elements (603, 801) are situated in front of the refractive optical elements such that the light passing through the refractive optical elements (602) pass through the re-directional optical elements (603, 801) prior to being emitted onto pre-defined locations on the region (111) visually appearing to the viewer (117).

10. An ambient lighting system according to claim 9, wherein the re-directional optical elements (603, 801) are selected from:
a transparent film having a repetitive prism-like structures, and
a negative lens covering at least one collimator.

11. An ambient lighting system according to claim 1, wherein the substantially point-like light sources (103) are mounted on a printed circuit board, the circuit board being adapted to conduct heat generated by the point-like light sources.

12. An ambient lighting system according to claim 1, further comprising an adjustment mechanism (120) connected to the substantial point-like light sources for adjusting the light sources, the adjustment including adjusting the angle position of the point-like light sources and the angle position of the emitted light beams.

13. An ambient lighting system according to claim 1, further comprising an adjustment mechanism comprising electronically adjustable optical element or re-directional optical element based on a liquid-crystal effect for adjusting the angle position of the emitted light beams onto the region visually appearing to the viewer.

14. An ambient lighting system according to claim 1, further comprising at least one elongated light guide (1401-1402, 1501-1504) comprising an out-coupling structure, the light guide being coupled to one or more of the substantial point-like light sources (103) such that the emitted light beam emitted by at least one of the substantially point-like light sources (103) becomes conducted into the light guide (1401-1402, 1501-1504) under an angle such that the light becomes guided by means of total internal reflection until it interacts with the out-coupling structure and becomes coupled out of the light guide (1401-1402, 1501-1504).

15. An ambient lighting system according to claim 1, further comprising a re-shaping mechanism for re-shaping the light beams such that each respective pixel in the pixelated regions has a pre-defined shape.

16. An ambient lighting system according to claim 15, wherein the re-shaping mechanism comprises an optical element formed two or more segments arranged in front of the substantially point-like light sources such that the emitted light means pass through the two or more segments, the shapes of the segments and their internal arrangement being such that the light beam will be re-directed differently to a fixed location on the region visually appearing to the viewer.

17. A display device (501) including an image display region comprising the ambient lighting system (100) according to claim 1.

18. A display device according to claim 15, wherein the display device (501) is selected from:
computer monitor display,
cathode ray tube (CRT) display,
a liquid crystal display (LCD),
an organic LED display (OLED),
a plasma discharge display, a projection display,
thin-film printed optically-active display,
or a display using a functionally equivalent display technology.
